(19) United States
(12) Patent Application Publication
(10) Pub. No.: US 2014/0363702 A1
(43) Pub. Date: Dec. 11, 2014

(54) FLEXIBLE ELECTRODE ASSEMBLY AND RECHARGEABLE BATTERY INCLUDING THE SAME

(71) Applicant: Samsung SDI Co., Ltd., Yongin-City (KR)

(72) Inventor: Bong-Young Kim, Yongin-City (KR)

(73) Assignee: Samsung SDI Co., Ltd., Yongin-City (KR)

(21) Appl. No.: 14/055,723

(22) Filed: Oct. 16, 2013

(30) Foreign Application Priority Data
Jun. 5, 2013 (KR) 10-2013-0064809

(51) Int. Cl. H01M 10/04

(52) U.S. Cl. CPC H01M 10/04
USPC 429/7; 429/246; 429/94; 429/163

(57) ABSTRACT

The electrode assembly of the present invention having an electrode layer including a positive electrode, a negative electrode, and a separator disposed between the positive electrode and the negative electrode includes a stacking portion where the electrode layer is overlapped and disposed, and a connection formed between the stacking portions to connect the stacking portions and having a smaller thickness than the stacking portion.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 10-2013-0064809 filed in the Korean Intellectual Property Office on Jun. 5, 2013, the entire contents of which are incorporated herein by reference.

### BACKGROUND

1. Field

The described technology relates generally to an electrode assembly and a rechargeable battery. More particularly, the described technology relates generally to a flexible electrode assembly and a rechargeable battery including the same.

2. Description of the Related Technology

A rechargeable battery can be repeatedly charged and discharged, unlike a primary battery that is incapable of being charged. A low capacity rechargeable battery has been used for small electronic devices such as a mobile phone, a laptop computer, and a camcorder, and a large capacity battery has been widely used as a power source for driving a motor of a hybrid vehicle.

Recently, high-output and large-capacity rechargeable batteries using a non-aqueous electrolyte with high energy density have been developed, and a plurality of the above high-output rechargeable batteries are connected in series or in parallel to constitute a high-output large-capacity battery module.

Typically, the rechargeable battery includes an electrode assembly having a positive electrode, a negative electrode, and a separator interposed between the positive electrode and the negative electrode. The electrode assembly is inserted into the case and performs the charge and discharge, and the case includes a terminal to receive or supply the current.

Currently, a flexible display such as an organic light emitting display is being developed, and to realize the flexible display, a flexible battery to supply power to the flexible display is required.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

The present invention provides a flexible cell.

An electrode assembly according to an embodiment of the present invention, having an electrode layer including a positive electrode, a negative electrode, and a separator disposed between the positive electrode and the negative electrode, includes: at least two stacking portions where the electrode layer is overlapped and disposed; and a connection formed between the stacking portions to connect stacking portions and having a smaller thickness than the stacking portion.

The electrode layer may be formed of a single layer in the connection, and the stacking portions may be deposited while being folded. The stacking portions may be deposited while being rolled.

Double-rolled electrode layers may be rolled together in the stacking portions, and the connection may include a hole or a cutout portion.

The positive electrode may have a positive electrode active material layer and the negative electrode may have an active material layer in the stacking portion, and the positive electrode may not include the positive electrode active material layer and the negative electrode may not include the negative active material layer in the connection. The connection may include an adhesive layer.

A rechargeable battery according to the present invention includes an electrode assembly including at least two stacking portions having a first thickness and a connection having a second thickness smaller than the first thickness, and a case receiving the stacking portion and having a plurality of groove portions.

The case may include a first cover where a plurality of groove portions and an adhesion portion connecting the groove portions are formed and a second cover coupled to the first cover, and the groove portions and the adhesion portion may be alternately arranged in one line.

The electrode layer may be formed of a single layer in the connection, and the stacking portion may be deposited while being bent. The stacking portion may be deposited while being rolled.

Double-rolled electrode layers may be rolled together in the stacking portion, the connection may include a hole or a cutout portion, and the adhesion portion is inserted into the hole or the cutout portion such that the first member and the second member may be interconnected.

The positive electrode may have a positive electrode active material layer and the negative electrode may have an active material layer in the stacking portion, and the positive electrode may not include the positive electrode active material layer and the negative electrode may not include the negative active material layer in the connection.

An adhesive layer may be formed between the connection and the adhesion portion, and the case may be formed of a laminate film.

The adhesion portion may be flexible, the rechargeable battery may further include a protective circuit module coupled to the case, and the protective circuit module may include a mounting portion facing the groove portion and installed with a circuit element and a flexible portion formed between the mounting portions while facing the adhesion portion and not mounting the circuit element.

The protective circuit module may include a flexible circuit board and a circuit element mounted thereto, the mounting portion may be formed of a printing circuit board, and the flexible portion may be formed of a cable connecting the printing circuit board.

According to an exemplary embodiment, the electrode assembly has the connection having the thin thickness such that the electrode assembly has flexibility. Also, the case receiving the electrode assembly includes a plurality of adhesion portions such that the rechargeable battery has flexibility.

### BRIEF DESCRIPTION OF THE DRAWINGS

FIG. 1 is a top plan view of a rechargeable battery according to the first exemplary embodiment.

FIG. 2 is a partial perspective view of a rechargeable battery according to the first exemplary embodiment.

FIG. 3 is a longitudinal cross-sectional view taken along the line III-III of FIG. 2.

FIG. 4 is a longitudinal cross-sectional view taken along the line IV-IV of FIG. 2.

FIG. 5 is an exploded sectional view of members shown in FIG. 4.

FIG. 6 is a front view of a bent state of a rechargeable battery according to the first exemplary embodiment.

FIG. 7 is a cross-sectional view of a rechargeable battery according to the second exemplary embodiment.

FIG. 8 is a partial perspective view of a rechargeable battery according to the second exemplary embodiment.

FIG. 9 is a cross-sectional view of an adhesion portion of a rechargeable battery according to the second exemplary embodiment.

FIG. 10 is an exploded sectional view of members shown in FIG. 9.

FIG. 11 is a cross-sectional view of a rechargeable battery according to the third exemplary embodiment.

FIG. 12 is an exploded perspective-sectional view of a rechargeable battery according to the fourth exemplary embodiment.

FIG. 13 is a cross-sectional view of a rechargeable battery according to the fourth exemplary embodiment.

FIG. 14 is an exploded perspective-sectional view of a rechargeable battery according to the fifth exemplary embodiment.

### DETAILED DESCRIPTION OF CERTAIN INVENTIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Like reference numerals designate like elements throughout the specification.

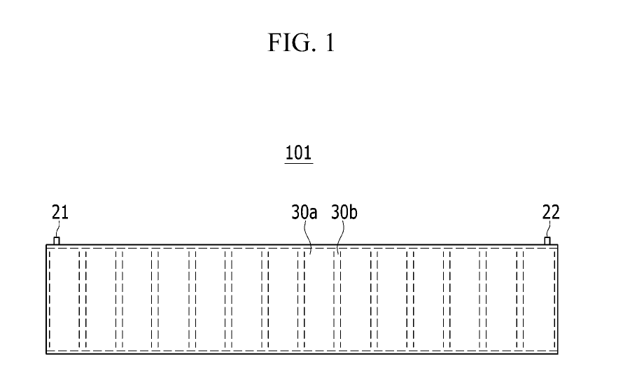

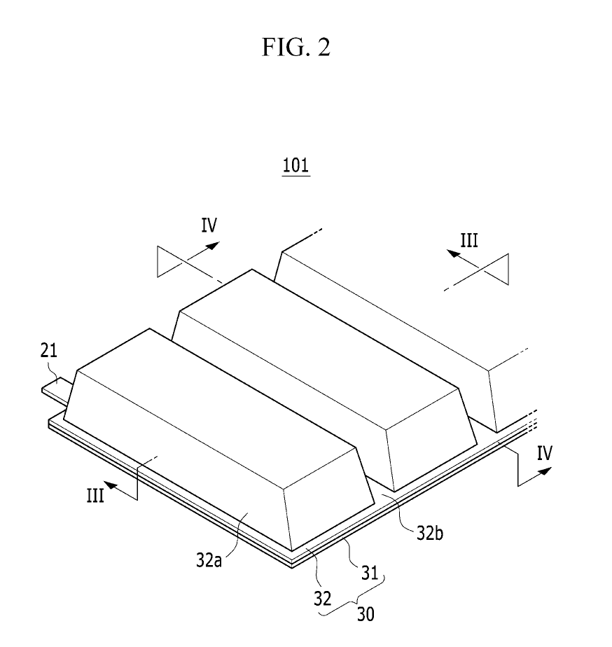

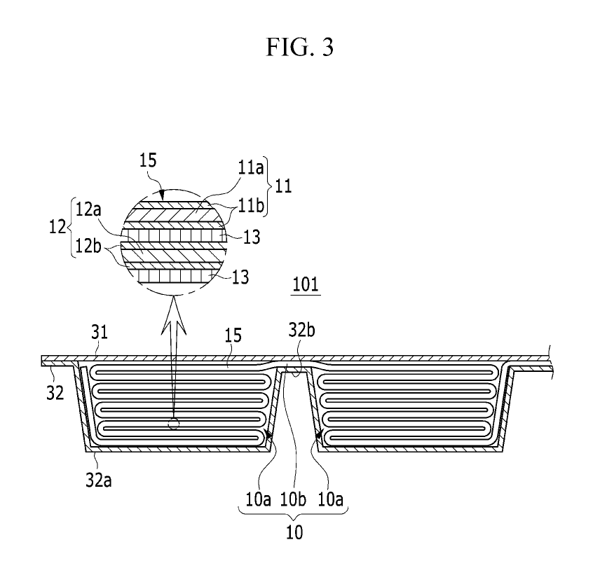

FIG. 1 is a top plan view of a rechargeable battery according to the first exemplary embodiment, FIG. 2 is a partial perspective view of a rechargeable battery according to the first exemplary embodiment, and FIG. 3 is a longitudinal cross-sectional view taken along the line III-III of FIG. 2.

Referring to FIG. 1, FIG. 2, and FIG. 3, a rechargeable battery 101 according to the present exemplary embodiment includes a case 30, an electrode assembly 10 inserted in and installed to the case 30, and a positive terminal 21 and a negative terminal 22 electrically connected to the electrode assembly 10.

The electrode assembly 10 includes an electrode layer 15 of a plate shape, and the electrode layer 15 has a positive electrode (the first electrode) 11 and a negative electrode (the second electrode) 12 with a separator 13 disposed between the positive electrode 11 and the negative electrode 12. The electrode assembly 10 includes a plurality of stacking portions 10a that the electrode layer 15 overlaps, and a connection 10b connecting the stacking portions 10a and made of the single electrode layer 15.

The positive electrode 11 includes a positive electrode current collector 11a made of a metal foil which is in the shape of a thin plate, and a positive electrode active material layer 11b formed on the positive electrode current collector 11a, while the negative electrode 12 includes a negative electrode current collector 12a and a negative active material layer 12b formed on the negative electrode current collector 12a.

The positive electrode 11 and the negative electrode 12 are formed with a long belt shape. The positive electrode 11 includes a positive electrode coating portion which is a region where the positive electrode active material layer 11b is coated, and a positive electrode uncoated portion which is a region where the positive electrode active material layer 11b is not coated. Also, the negative electrode 12 includes a negative electrode coating portion which is a region where the negative active material layer 12b is coated, and a negative uncoated portion which is a region where the negative active material layer 12b is not coated.

The positive electrode uncoated portion 11b is positioned at one end in the length direction of the electrode assembly 10, and the negative uncoated portion 12b is positioned at the other end in the length direction of the electrode assembly 10. The positive terminal 21 is adhered to the positive electrode uncoated portion to be electrically connected to the positive electrode, and the positive terminal 21 is adhered to the negative uncoated portion to be electrically connected to the positive electrode.

The case 30 includes a first cover 32 having a plurality of groove portions 32a and a second cover 31 coupled to the first cover 32. The plurality of groove portions 32a are disposed in one line at the first cover 32, and an adhesion portion 32b connecting the groove portions 32a is formed between the groove portions 32a. The groove portion 32a and the adhesion portion 32b are alternately disposed in one line. The second cover 31 is formed with a plate shape and is adhered to the adhesion portion of the first cover 32 thereby sealing the groove portion 32a.

The stacking portion 10a is inserted into the groove portion 32a and the connection 10b is disposed on the adhesion portion 32b. Also, a flange portion to which the first cover 32 and the second cover 31 are adhered is formed at the edge of the case 30 to seal the case 30. The first cover 32 and the second cover 31 may be formed of a laminated film of which a polymer is coated on both surfaces of a metal thin film.

As shown in FIG. 1, the case 30 includes a first region 30a that is not bent and a second region 30b that is flexible, and a portion where the groove portion 32a is formed to be thick becomes the first region 30a and a portion where the adhesion portion 32b is positioned to be thin becomes the second region 30b.

As shown in FIG. 3, in the stacking portion 10a, the electrode layer 15 is deposited and disposed to be bent with a zigzag shape, and has a relatively larger thickness than the connection 10b. The stacking portion 10a is inserted and installed to the groove portion 32a, and the stacking portion 10a and the connection 10b are alternately disposed to be continued in one line.

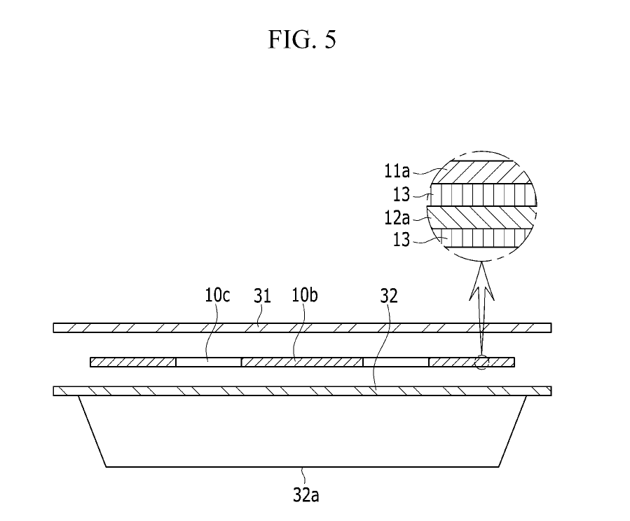

The connection 10b is formed of the single electrode layer and connects the stacking portions 10a. As shown in FIG. 5, in the connection 10b, the positive electrode 11 only includes the positive electrode current collector 11a, and the positive electrode active material layer 11b is not coated at the positive electrode current collector 11a. Also, in the connection 10b, the negative electrode 12 only includes the negative electrode current collector 12a, and the negative active material layer 12b is not coated at the negative electrode current collector 12a.

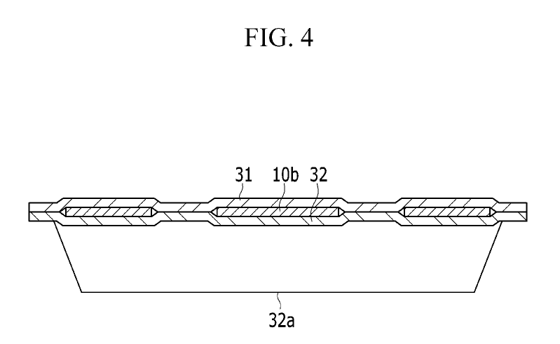

As shown in FIGS. 4 and 5, the connection 10b includes a plurality of holes 10c, and the first cover 32 and the second cover 31 are contacted and adhered through the holes 10c such that the adhered portion penetrates the holes 10c and is melted. If the adhesion portion 32b of the first cover 32 is adhered to the second cover 31, the case 30 may support the electrode assembly 10 and may seal between the groove portions 32a.

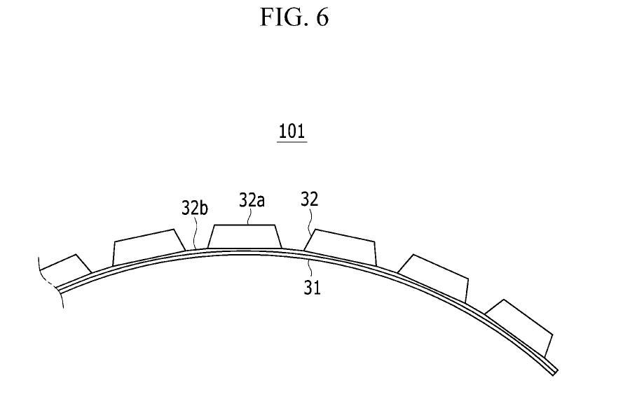

Also, like the present exemplary embodiment, if the electrode assembly 10 includes the stacking portion 10a and the connection 10b and the stacking portion 10a is inserted and installed to the groove portion 32a formed at the case 30, as shown in FIG. 6, a battery having flexibility may be obtained. The stacking portion 10a has a relatively thick thickness such that the flexibility is low, however the connection 10b has high flexibility such that it may be easily bent. If the stacking portion 10a and the connection 10b are alternately disposed, the rechargeable battery may be naturally bent.

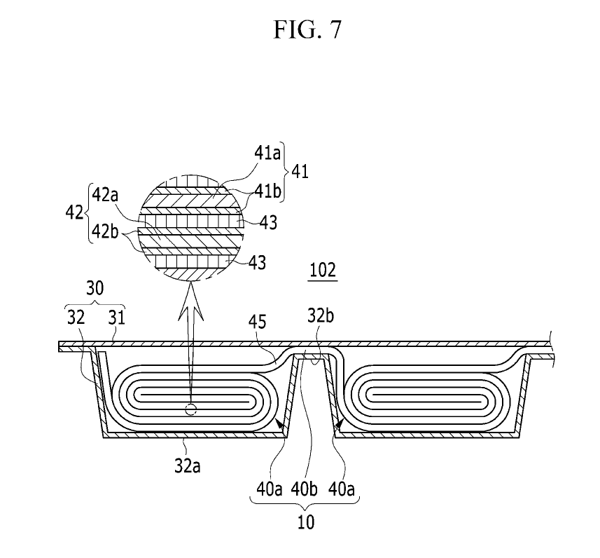

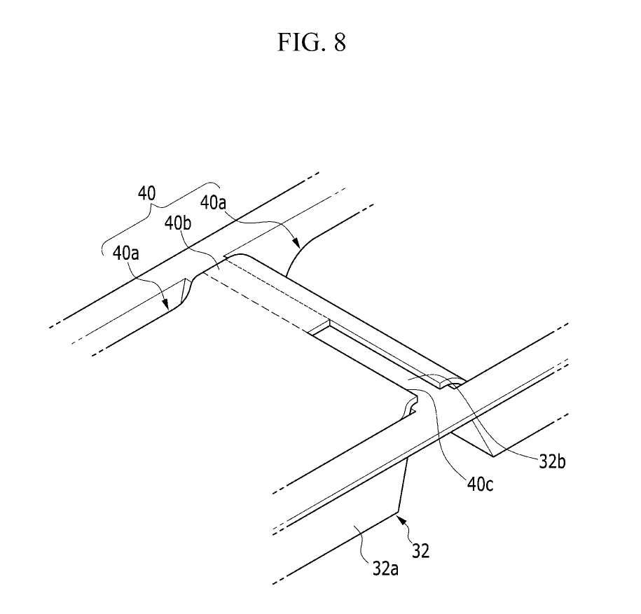

FIG. 7 is a cross-sectional view of a rechargeable battery according to the second exemplary embodiment, and FIG. 8 is a partial perspective view of a rechargeable battery according to the second exemplary embodiment.

Referring to FIG. 7 and FIG. 8, the rechargeable battery 102 according to the present exemplary embodiment includes a case 30 and an electrode assembly 40 inserted into the case 30.

The electrode assembly 40 includes an electrode layer 45 with a plate shape, and the electrode layer 45 has a positive electrode (the first electrode) 41 and a negative electrode (the second electrode) 42 with a separator 43 disposed between the positive electrode 41 and the negative electrode 42. The electrode assembly 40 includes stacking portions 40a and a connection 40b. The stacking portions 40a are formed of a structure that the electrode layer 45 overlaps, and the connection 40b connects the stacking portions 40a and is formed with the single electrode layer 45.

The case 30 includes a first cover 32 having a plurality of groove portions 32a and a second cover 31 coupled to the first cover 32. A plurality of groove portions 32a are disposed in one line at the first cover 32, and an adhesion portion 32b connecting the groove portions 32a is formed between the groove portions 32a. The groove portion 32a and the adhesion portion 32b are alternately arranged. The second cover 31 is formed with a plate shape and is adhered to the adhesion portion of the first cover 32 thereby sealing the groove portion 32a.

The stacking portion 40a is inserted into the groove portion 32a and the connection 40b is disposed on the adhesion portion 32b. The electrode layer 45 with a rolled shape is deposited and disposed at the stacking portion 40a, and has a relatively large thickness compared with the connection 40b. Particularly, two electrode layers 45 are rolled together in the stacking portion 40a. The stacking portion 40a is double-rolled at the center, and two ends are formed outside the stacking portion 40a.

One end of the stacking portion 40a is continued to the neighboring connection 40b of one side and the other end is continued to the neighboring connection 40b of the opposite side. Accordingly, although the stacking portion 40a is formed of the spiral-wound structure, both ends are positioned outside such that the neighboring connections 40b may be connected.

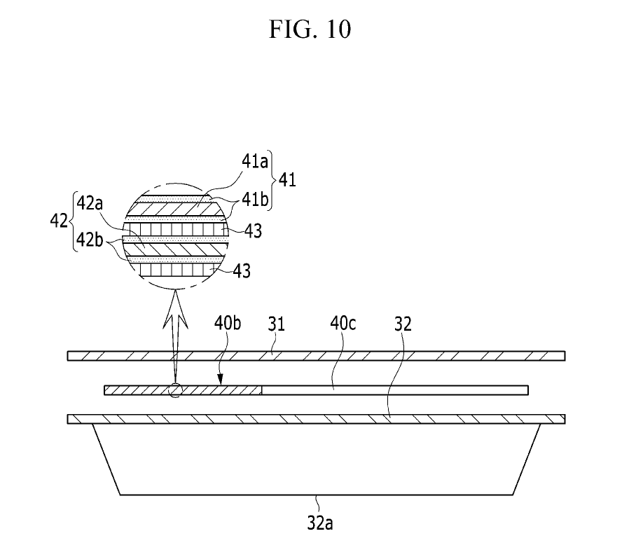

As shown in FIG. 10, meanwhile, the connection 40b is formed of the single electrode layer 45 and connects the stacking portions 40a. In the connection 40b, the positive electrode 41 includes a positive electrode current collector 41a and a positive electrode active material layer 41b. Also, in the connection 40b, the negative electrode 42 includes a negative electrode current collector 42a and a negative active material layer 42b.

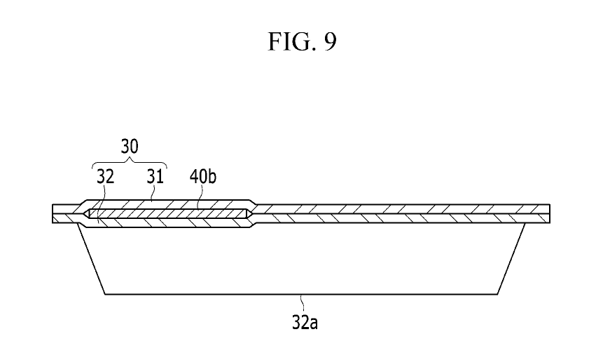

As shown in FIG. 8 and FIG. 9, a cutout portion 40c is formed at the connection 40b. The cutout portion 40c is only formed at the portion of the connection 40b, and the first cover 32 and the second cover 31 are contacted and adhered through the cutout portion 40c. At this time, the first cover 32 and the second cover 31 may be adhered by melting.

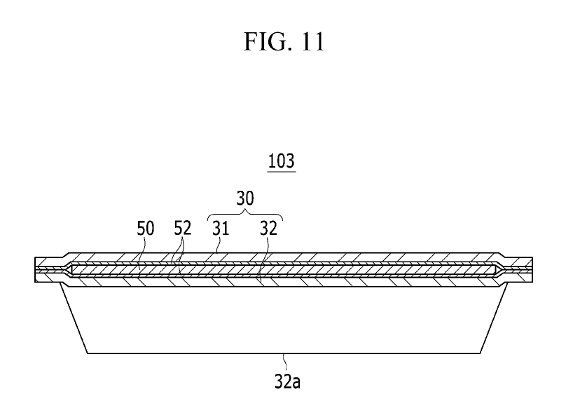

FIG. 11 is a cross-sectional view of a rechargeable battery according to the third exemplary embodiment.

The rechargeable battery 103 according to the present exemplary embodiment is formed of the same structure as the rechargeable battery according to the first exemplary embodiment except for the structure in which an electrode assembly 50 and a case 30 are coupled such that the overlapping description for the same structure is omitted.

The rechargeable battery 103 according to the present exemplary embodiment includes the case 30 and the electrode assembly 50 inserted and installed in the case 30.

The electrode assembly 50 includes the stacking portion and the connection. The case 30 includes a first cover 32 having a plurality of groove portions 32a and a second cover 31 coupled to the first cover 32. The stacking portion is inserted into the groove portion 32a and the connection is coupled between the first cover 32 and the second cover 31. In the connection, an adhesive layer 52 is formed between the case 30 and the electrode assembly 50, and the case 30 and the electrode assembly 50 are fixed by the adhesive layer 52. The adhesive layer 52 may be made of a double-sided tape, or a polymer having adhesiveness.

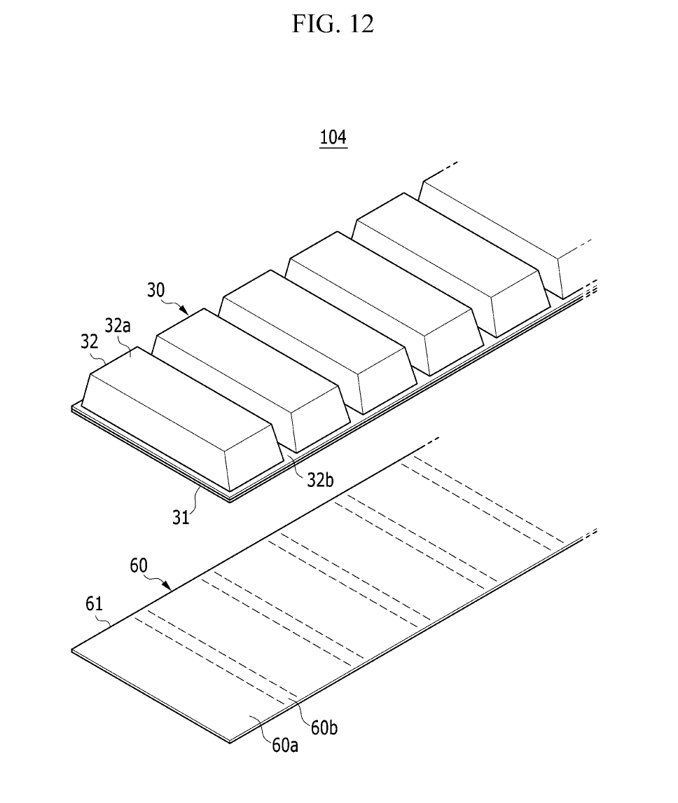

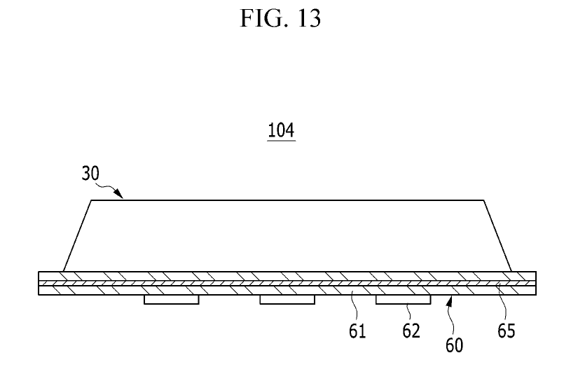

FIG. 12 is an exploded perspective view of a rechargeable battery according to the fourth exemplary embodiment, and FIG. 13 is a cross-sectional view of a rechargeable battery according to the fourth exemplary embodiment.

Referring to FIG. 12 and FIG. 13, the rechargeable battery 104 according to the present exemplary embodiment includes a case 30, an electrode assembly inserted into the case 30, and a protective circuit module 60 coupled to the case 30 and controlling charge and discharge.

The electrode assembly and the case 30 have the same structure as the rechargeable battery according to the first exemplary embodiment such that the overlapping description for the same structure is omitted. The case 30 includes a first cover 32 and a second cover 31, and a groove portion 32a and an adhesion portion 32b are formed at the first cover 32.

The protective circuit module 60 includes a substrate 61 and a protective circuit element 62 formed on the substrate 61. The protective circuit element 62 includes a sensor measuring the state of charge of the electrode assembly and circuit elements controlling the charge and discharge. The protective circuit element 62 is only positioned at the mounting portion, and the protective circuit element is not mounted at the flexible portion. The substrate 61 is made of a flexible printed circuit board (FPCB) having flexibility.

The protective circuit module 60 includes a mounting portion 60a to which the protective circuit element 62 is mounted, and a flexible portion 60b formed between the mounting portions 60a and connecting the mounting portions 60a. The mounting portion 60a is disposed to face the groove portion 32a, and the flexible portion 60b is disposed to face the adhesion portion 32b of the case 30.

As described above, according to the present exemplary embodiment, the flexible portion 60b is disposed to face the adhesion portion 32b of the case 30 such that the rechargeable battery may be easily bent without an interruption in the protective circuit element 62.

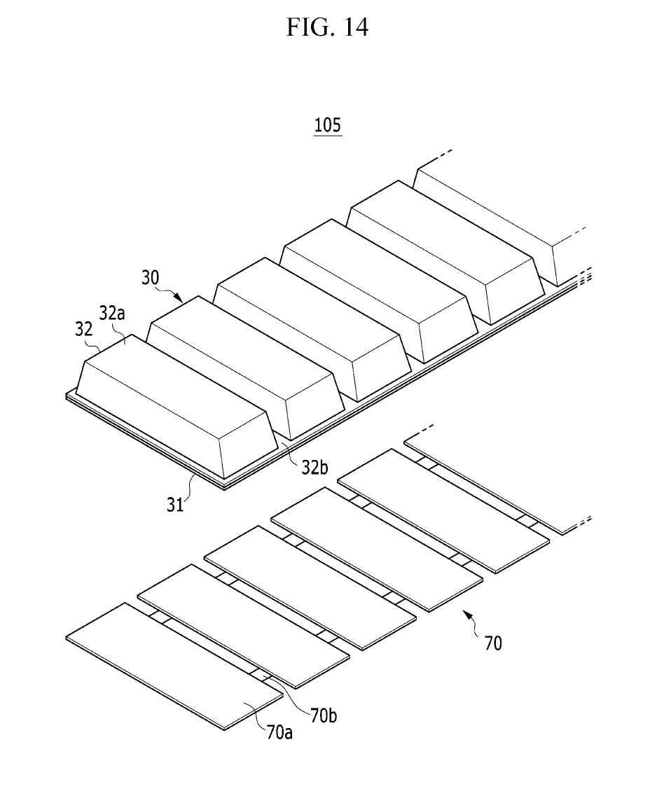

FIG. 14 is an exploded perspective view of a rechargeable battery according to the fifth exemplary embodiment.

Referring to FIG. 14, the rechargeable battery 105 according to the present exemplary embodiment includes a case 30, an electrode assembly inserted in the case 30, and a protective circuit module 70 coupled to the case 30 and controlling the charge and discharge.

The electrode assembly and the case 30 have the same structure as the rechargeable battery according to the first exemplary embodiment such that the overlapping description for the same structure is omitted. The case 30 includes a first cover 32 and a second cover 31, and a groove portion 32a and an adhesion portion 32b are formed at the first cover 32.

The protective circuit module 70 includes a substrate 71 and a protective circuit element formed on the substrate 71. The protective circuit element includes a sensor measuring the state of charge of the electrode assembly and circuit elements controlling the charge and discharge. The substrate 71 is made of a printing circuit board or a flexible printed circuit board (FPCB) having flexibility.

The protective circuit module 70 includes a mounting portion 70a to which the protective circuit element 72 is mounted and a flexible portion 70b formed between the mounting portions 70a and connecting the mounting portions 70a. The protective circuit element 72 is only positioned at the mounting portion 70a, and the protective circuit element is not mounted at the flexible portion 70b. The mounting portion 70a is formed of the substrate and the flexible portion 70b is formed of a cable connecting the mounting portions 70a. The flexible portion 70b has a function of transmitting data or supplying power to the connected mounting portions 70a.

The mounting portion 70a is disposed to face the groove portion 32a, and the flexible portion 70b is disposed to face the adhesion portion 32b of the case 30.

As described above, according to the present exemplary embodiment, the flexible portion 70b is disposed to face the adhesion portion 32b of the case 30 such that the rechargeable battery may be easily bent without an interruption in the protective circuit element.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrode assembly having an electrode layer including a positive electrode, a negative electrode, and a separator disposed between the positive electrode and the negative electrode, comprising:
at least two stacking portions where the electrode layer is overlapped and disposed; and
a connection formed between stacking portions to connect the stacking portions and having a smaller thickness than the stacking portions.

2. The electrode assembly of claim 1, wherein the electrode layer is formed of a single layer in the connection.

3. The electrode assembly of claim 1, wherein the stacking portions are deposited while being folded.

4. The electrode assembly of claim 1, wherein the stacking portions are deposited while being rolled.

5. The electrode assembly of claim 4, wherein double-rolled electrode layers are rolled together in the stacking portions.

6. The electrode assembly of claim 1, wherein the connection includes a hole or a cutout portion.

7. The electrode assembly of claim 1, wherein
the positive electrode has a positive electrode active material layer and the negative electrode has an active material layer in the stacking portions, and
the positive electrode does not include the positive electrode active material layer and the negative electrode does not include the negative active material layer in the connection.

8. The electrode assembly of claim 1, wherein the connection includes an adhesive layer.

9. A rechargeable battery comprising:
an electrode assembly including at least two stacking portions having a first thickness and a connection having a second thickness smaller than the first thickness; and
a case receiving the stacking portions and having at least two groove portions.

10. The rechargeable battery of claim 9, wherein the case includes a first cover where at least two groove portions and an adhesion portion connecting the groove portions are formed, and a second cover coupled to the first cover.

11. The rechargeable battery of claim 10, wherein the groove portions and the adhesion portion are alternately arranged in one line.

12. The rechargeable battery of claim 10, wherein the electrode layer is formed of a single layer in the connection.

13. The rechargeable battery of claim 10, wherein the stacking portions are deposited while being bent.

14. The rechargeable battery of claim 10, wherein the stacking portions are deposited while being rolled.

15. The rechargeable battery of claim 14, wherein double-rolled electrode layers are rolled together in the stacking portions.

16. The rechargeable battery of claim 10, wherein the connection includes a hole or a cutout portion, and the adhesion portion is inserted into the hole or the cutout portion such that the first cover and the second cover are interconnected.

17. The rechargeable battery of claim 10, wherein:
the positive electrode has a positive electrode active material layer and the negative electrode has an active material layer in the stacking portions; and
the positive electrode does not include the positive electrode active material layer and the negative electrode does not include the negative active material layer in the connection.

18. The rechargeable battery of claim 10, wherein an adhesive layer is formed between the connection and the adhesion portion.

19. The rechargeable battery of claim 10, wherein the case is formed of a laminate film.

20. The rechargeable battery of claim 10, wherein the adhesion portion is flexible.

21. The rechargeable battery of claim 10, further comprising
a protective circuit module coupled to the case,
wherein the protective circuit module includes a mounting portion facing the groove portion and installed with a circuit element, and
a flexible portion formed between the mounting portions while facing the adhesion portion and not mounting the circuit element.

22. The rechargeable battery of claim 21, wherein the protective circuit module includes a flexible circuit board and a circuit element mounted thereto.

23. The rechargeable battery of claim 21, wherein the mounting portion is formed of a printing circuit board, and the flexible portion is formed of a cable connected to the printing circuit board.
